(19) United States
(12) Patent Application Publication
(10) Pub. No.: US 2009/0185391 A1
(43) Pub. Date: Jul. 23, 2009

(54) Marker light fixture for scale model train

(75) Inventors: Michael P. Wolf, Highland, MD (US); David L. Krebiehl, Saint Joseph, MI (US); Young Jun Jung, Gyeonggi-Do (KR)

Correspondence Address: MCDERMOTT WILL & EMERY LLP, 600 13TH STREET, N.W., WASHINGTON, DC, 20005-3096, US

(73) Assignee: MIKE'S TRAIN HOUSE, INC.

(21) Appl. No.: 12/010,022

(22) Filed: Jan. 18, 2008

(51) Int. Cl. G02B 6/00

(52) U.S. Cl. 362/551

(57) ABSTRACT

A light fixture for a scale model structure including a waveguide for transmitting light. The wave guide includes a transparent substrate; a first end for receiving light; a second end for emitting light from one or more output apertures; and a light scattering portion with an index of refraction substantially different from the transparent substrate, which scatters or reflects light received at the first end so as to emit light from the output apertures.

### FIELD OF THE INVENTION

The present invention relates generally to the illumination of scale model structures, and more specifically, to marker lights, classification lights, and other light fixtures for use with scale model structures.

### BACKGROUND OF THE INVENTION

In the art of constructing model trains, fidelity to actual trains, known as “prototypes” in the field, is a serious pursuit. One particular aspect of interest in model train construction has been the faithful reproduction of marker lights. These are lighting fixtures on prototype trains, typically serving as “markers” for the leading and trailing ends of trains of cars. Although initially satisfied with unlit marker lights, ever since incandescent light bulbs became small enough to fit in model train cars, model train enthusiasts have sought to illuminate model train cars in ways faithfully resembling their prototypes, including illuminated marker lights.

On prototype trains, marker lights were often in the form of lanterns, with a number of lenses pointing in different directions and in various colors. For example, on the front of a steam engine, each front corner of the boiler might bear a marker light. Typically, each marker light has two lenses, one directed forward and the other to the side, both of which are either white or clear. On cabooses at the trailing end of trains, there might be marker lights at each of the trailing corners of the car. Typically these marker lights have three lenses, respectively directed forward, rearward, and to the side. Usually the forward and side lenses are green, and the rearward lens red, although in some instances lenses are yellow.

There are a number of ways that marker lights are incorporated into model trains. For some, simple metal casting replicas mounted on cars suffice. Others seek illuminated marker lights, to more accurately depict their prototypes. Although faithful and functional reproductions of marker lights have been incorporated into model trains for decades, they are generally labor intensive efforts performed by individual enthusiasts. Primarily there have been two types of designs.

In the first type of design, one starts with solid metal castings of marker lights at an appropriate scale, which are readily available. The castings are drilled out from the bottom so as to accommodate a very small light bulb. The castings are also drilled out from the sides to provide apertures for light to escape, reproducing the lens apertures on prototype marker lights. Then, a small light is placed inside the hollowed casting. The light is often a small “grain of wheat” incandescent bulb or, more recently, a light-emitting diode (“LED”). After orienting the light source so as to provide illumination from the side holes, it is typically permanently glued in place, requiring drilling out the bulb when replacement becomes necessary. Then, transparent colored material, such as plastic, is cut to fit the holes in the side to give the red/green/yellow coloring to the light apertures so as to match the prototype. Wires are soldered to the leads of the light source. These wires are frequently used to support the marker light, with care taken so as to not break the fragile leads of the light or fine wires attached to the light.

The recent use of light emitting diodes in the above design provides benefits such as greater longevity, lower power consumption, and less heat generation. In addition, LEDs can be employed as diodes in the electric circuits. But light emitting diodes, even without a lens element, emit light with greater directivity than incandescent bulbs. Because of this, one lens of a marker light is usually brighter than the others, particularly for marker lights with three lens apertures.

In the second type of design, a light bulb is placed inside of a model train car. Short lengths of fiber optics are cut, and then bent at a 90 degree angle after immersing them in hot water. Holes are drilled in the sides or corners of the car, and the tip of the fiber optic, usually rounded off, is mounted so the tip barely extends out of the side of the car. Black paint is applied to the protruding tip to reduce the size of the light spot, and a small piece of colored plastic is placed over the tip to give the emitted light a color. Thus, the typical result is that a light is emitted at the correct location on the car, but without the lantern-like fixture commonly seen on prototypes. In other similar designs, a Y-shaped Lucite structure, either cut from a sheet or using bent tubes, is used instead of fiber optics. In the Lucite designs, two ends of the Y-shaped structure extend out from the sides of the car, and are milled and painted so as to resemble the shape of prototype marker lights. Then colored “jewels” are added to provide red, green, or yellow lenses. A drawback of the above designs is that by routing light through an optical pipe that is gently curved, such designs are not particularly compact.

As noted above, such designs are usually constructed by hand by individual enthusiasts, and are often fragile. Thus there is a need, particularly among manufacturers of scale model structures, for a way of incorporating illuminated light fixtures into scale model structures that is less labor intensive, less fragile, more compact, and has a greater lifespan. Further, the manufacturing of the light fixtures themselves needs to be inexpensive and simple. Accordingly, there is a need for light fixtures for scale model structures that satisfy these needs, and which produce even lighting from the lens apertures so as to more faithfully represent prototypes.

### SUMMARY OF THE INVENTION

In one embodiment of the invention, a light fixture for a scale model structure comprises a waveguide for transmitting light including a transparent substrate; a first end for receiving light; a second end for emitting light from at least two substantially orthogonally directed output apertures; and a light scattering portion with an index of refraction substantially different from the transparent substrate, which scatters or reflects light received at the first end such that the output apertures emit approximately equal amounts of light; and an opaque outer layer covering the exterior of the waveguide, excluding the first end and the output apertures.

In another embodiment of the invention, a scale model structure comprises one or more light fixtures each including a waveguide for transmitting light comprising a transparent substrate; a first end for receiving light; a second end for emitting light from at least two substantially orthogonally directed output apertures; and a light scattering portion with an index of refraction substantially different from the transparent substrate, which scatters or reflects light received at the first end such that the output apertures emit approximately equal amounts of light; and an opaque outer layer covering the exterior of the waveguide, excluding the first end and the output apertures.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 illustrates an exemplary first embodiment of the invention.

FIG. 2 illustrates a side view of an exemplary second embodiment, with two output apertures.

FIG. 3 illustrates a top view of the second embodiment illustrated in FIG. 2.

FIG. 4 illustrates an exemplary third embodiment designed for and placed in a boiler of a model train engine.

FIG. 5 illustrates a third embodiment designed for and placed in a of a model train tender structure.

### DETAILED DESCRIPTION OF THE INVENTION

It is contemplated that the subject matter described herein may be embodied in many forms. Accordingly, the embodiments described in detail below are the presently preferred embodiments, and are not to be considered limitations. Similar numerals in figures may designate similar, but not necessarily identical, embodiments of inventive elements.

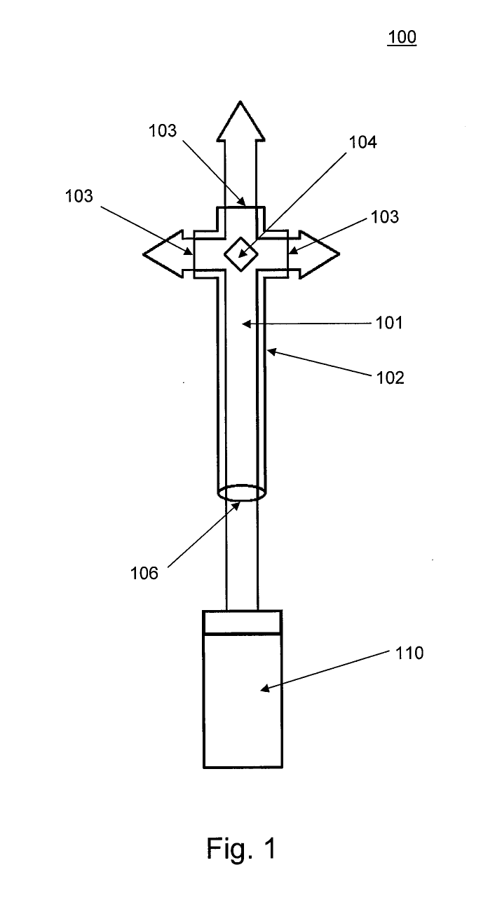

FIG. 1 is a simplified illustration of a first embodiment of the invention. The marker light fixture 100 comprises a substantially straight waveguide 101 manufactured from a transparent substrate material, such as, but not limited to, plastic. Preferred plastic materials include polycarbonate or acrylic. Polycarbonate is preferred, as it is strong, offers excellent optical properties for passing light, and may be tinted with a dye. The waveguide is typically manufactured by plastic injection molding, which offers an inexpensive and effective way of obtaining the desired clarity and optical performance. The surfaces of the tooling for injection molding are highly polished to obtain proper optical clarity of the molded parts.

A light source 110, for example, but not limited to, a light emitting diode, often constructed with a lens for shaping or focusing its output into a more concentrated beam, is directed at the input 106 of the waveguide 101, which is located at one end of the waveguide 101. In some embodiments, there may be a plurality of inputs for receiving light.

In the given embodiment, the opposite end of the waveguide 101 provides three substantially orthogonally directed output apertures 103 for emitting light. At the end of the waveguide 101 with the output apertures 103, the marker light fixture 100 is shaped to resemble a prototypical marker light, with the output apertures 103 situated in a manner similar to the lenses of a prototype marker. The apertures may be, for example, rounded and have additional details to more closely resemble the lenses of a prototype marker light. Each of the three output apertures 103 may have a transparent colored covering, such that emitted light has a color cast that accurately portrays the prototypical marker light, often red, green or yellow. Alternatively, the substrate of waveguide 101 may be a colored material such that output apertures 103 emit colored light without requiring the transparent colored covering described above. Alternatively, a colored light source 1 10, including light sources that can output multiple colors, may be used. A multi-colored light sources, such as a multi-colored LED, might change the color of light output in response to operation of a model train comprising the light fixture, such as for indicating the direction of travel of a model train.

In the preferred embodiment, around the exterior of the waveguide 101 there is an opaque outer layer 102, except over the input aperture 106 and output apertures 103. The opaque outer layer 102 may be, but is not limited to, plastic or paint, and is typically a black paint. In some embodiments, a transparent waveguide 101 is molded with a detailed exterior appearance, and then paint is applied as the opaque outer layer 102. In other embodiments, a transparent waveguide 101 is insert molded into a plastic housing which provides a detailed exterior appearance and serves as opaque outer layer 102. The outer layer 102 prevents unwanted leakage of light along the length of the waveguide 101. Also, at the boundary where the waveguide 101 and outer layer 102 meet, light is reflected, which aids the transmission of light through the waveguide 101. By way of example, in an embodiment similar to that depicted in FIG. 1 produced at a size appropriate for a marker light fixture for an HO scale model train, a diameter of the waveguide would be on the order of 1.7 mm.

Near the output apertures 103 there is a light scattering portion 104. The light scattering portion 104 comprises a discontinuity in the substrate with a different index of refraction, and usually is an air gap. Due to different indexes of refraction between the waveguide 101 and the air gap, light is scattered by reflective, refractive, and transmissive optical effects, the respective degree of each effect depending on factors such as the index of refraction, shape, size, and orientation of the light scattering portion 104. The effect of these factors may be estimated using various commercially available geometric optical simulation software products. The desired effect of the light scattering portion 104 is to divert light into directions other than that of the light source. With the light scattering portion 104 present, the output apertures 103 emit approximately equal amounts of light. Without the light scattering portion 104, the light output would be much less equally distributed among the output apertures 103. Thus, the waveguide 101, outer layer 102, and light scattering portion 104 function together so as to scatter and split light supplied to input aperture 106 into different directions and multiple output surfaces.

In the first embodiment, an exemplary light scattering portion 104 is a square hole molded into the waveguide 101. By providing surfaces at a 45 degree angle incident to the light received from the light source 110, a portion of the light is reflected to make a 90 degree turn. The size of the scattering element relates to the size of the waveguide. By way of example, in an embodiment similar to that depicted in FIG. 1 produced at a size appropriate for a marker light fixture for an HO scale model train, the light scattering portion would be on the order of 1 mm across. In other embodiments, other shapes for the light scattering portion 104 may be appropriate, including, but not limited to, rectangular prisms, spheres, hemispheres, or cylinders. The selection of such shapes is affected in part by the desired shape for the waveguide 101 and the number and positions of the output apertures 103.

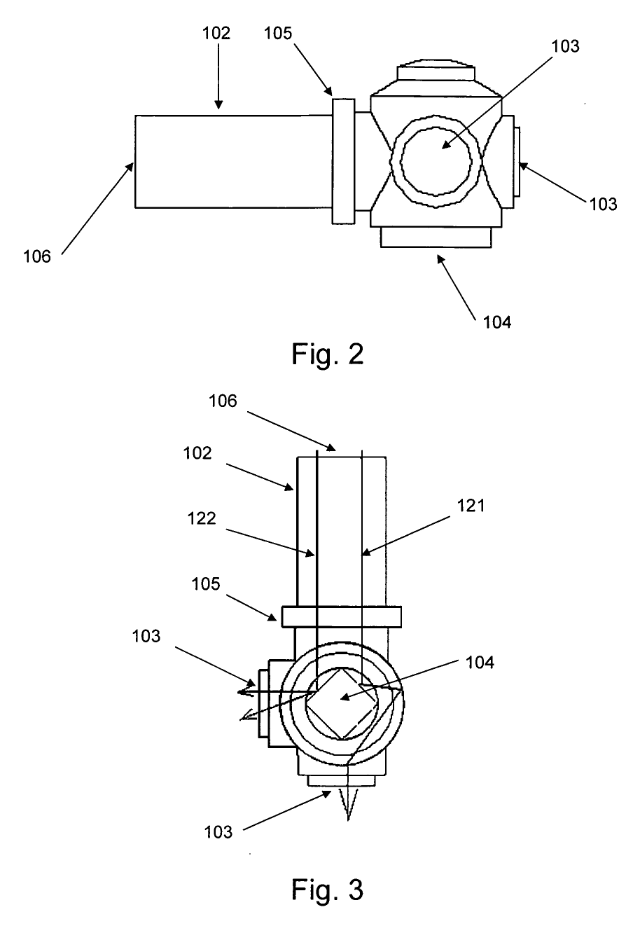

FIG. 2 illustrates a side view of a second embodiment with only two output apertures 103. As discussed above, the portion of marker light fixture 100 around the output apertures 103 is shaped to resemble a prototypical marker light. Additionally, the marker light fixture 100 has a collar 105, which when the light fixture is installed in a model train structure, the collar 105 rests against a wall so as to control the depth at which the marker light fixture 100 is installed into a model train structure. Although not depicted in the figures, the portion of the marker light fixture 100 that passes through a model train structure wall may also be formed with a particular shape, matching a respective shape for its respective hole in a wall, so that the marker light fixture 100 can be easily and accurately oriented on the model train structure.

In this embodiment, the light scattering portion 104 is an air gap that has an opening exposed at the bottom of the marker light fixture 100. By using an exposed air gap as the light scattering portion 104, the waveguide 101 substrate may be constructed using a single material, such as transparent plastic, which is molded so as to have an open air gap for light scattering. In the embodiment, the light scattering element is structured to reduce the amount of light emitted through the opening. The use of a single material and the exposed air hole for the waveguide 101 simplifies and reduces the cost of manufacturing the waveguide 101, as molding is simplified. Alternatively, the light scattering portion 104 might not be exposed, such as an air bubble or other enclosed cavity in the waveguide 101 substrate, possibly depending on the desired method of construction. Also, the open end may be sealed with an opaque material, such as an embodiment where the outer layer 102 covers the gap. Also, the light scattering portion 104 might comprise some material other than air, such as another solid material or a liquid or gas. The selection of material may be guided in part by the refractive index of a candidate material, as well as by other factors including the practicality of a given material for a given application and its expense. In some embodiments, the light scattering portion 104 may comprise a highly reflective material. For example, a polished chrome part, a chrome plated part, or other part comprising highly reflective material may be inserted in a gap such as the square gap illustrated in FIG. 1. In some embodiments, various surfaces may be selectively chrome plated, or otherwise made reflective, such that light can pass through or be scattered by some parts of a light scattering portion, and also reflected chrome plated surfaces.

FIG. 3 presents a top view of the embodiment illustrated in FIG. 2. The figure illustrates how light may be reflected by the light scattering portion 104. Light scattering portion 104 has a square shape in this cross section, with faces set roughly at a 45 degree angle to the axis of the straight portion of waveguide 101. A light ray 121 reflects off a face of the light scattering portion 104, then reflects at the exterior interface of the waveguide 101, and emerges from output aperture 103. This illustrates that although light scattering does occur in directions other than the output apertures 103, the light is usually reflected so as to ultimately emerge from an output aperture 103. Another light ray 122 reflects off another face of the light scattering portion 104 to more directly emerge from the other light aperture 103.

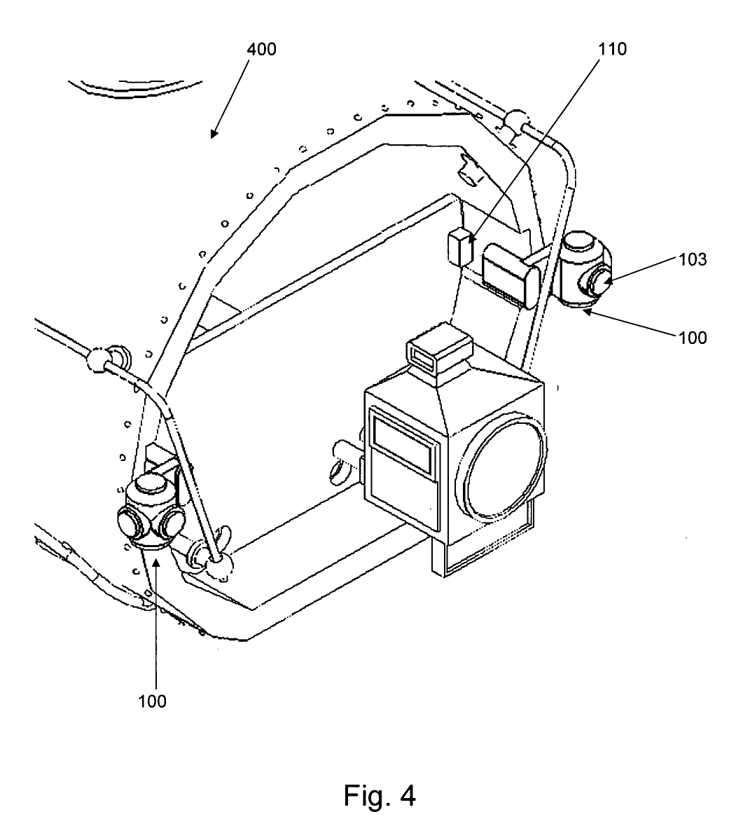

FIG. 4 illustrates an embodiment installed in a model train engine structure 400 based on a prototypical boiler. In this embodiment, the waveguide 101 is not substantially straight, as has been illustrated in other embodiments above, but instead exhibits a 90 degree angle. Nevertheless, the waveguide 101 still transmits a substantial amount of the light to the output apertures 103. This particular design better accommodates space and assembly considerations imposed by the location of the marker light fixture 100 and the overall design of the structure.

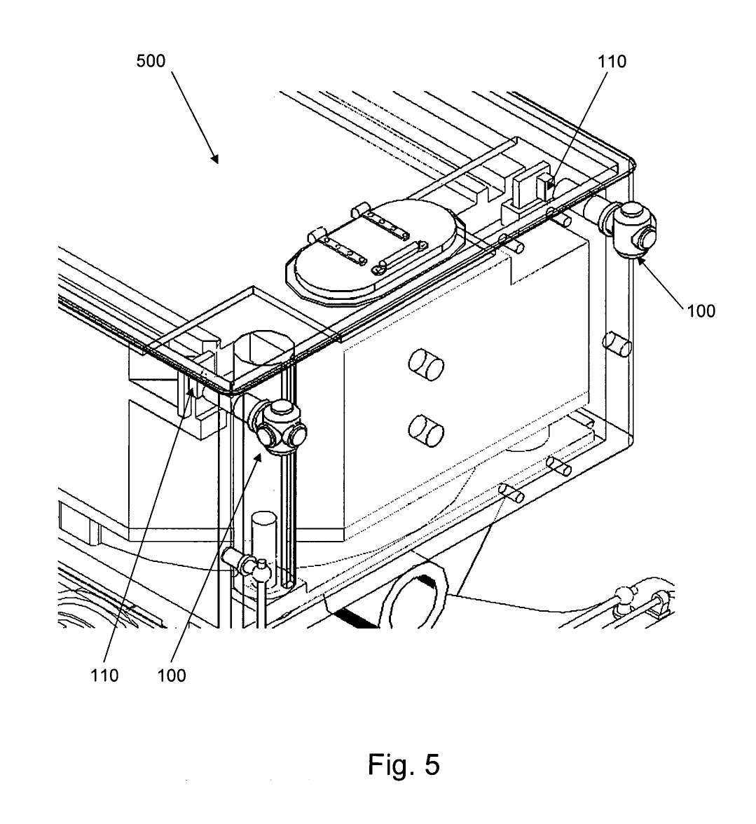

FIG. 5 illustrates another embodiment, similar to the one depicted in FIGS. 2 and 3, installed in a model train tender structure 500. For this particular model train structure, a straightened design is more useful in consideration of interior design features. There are many other types of model train structures which may incorporate marker light fixtures, including, but not limited to: engines, motors, boxcars, tenders, trolleys, freight cars, cabooses, buildings, and lamps. The dimensions of a marker light fixture are also appropriate for the scale of the model train structure for which it is intended. There are many popular scales for model trains, including, but not limited to, Large, G, LGB, half, I, O, S, HO, TT, N, and Z scales.

Although embodiments are disclosed above for use with scale model trains, embodiments may also be directed to other scale model structures, such as, but not limited to, light fixtures for model automobiles and scale model buildings.

Although certain specific embodiments of the present invention have been disclosed, it is noted that the present invention may be embodied in other forms without departing from the spirit or essential characteristics thereof. The present embodiments are therefore to be considered in all respects as illustrative and not restrictive, the scope of the invention being indicated by the appended claims, and all changes that come within the meaning and range of equivalency of the claims are therefore intended to be embraced therein.

What is claimed is:

1. A scale model structure comprising:
at least one light fixture, said light fixture comprising
a waveguide for transmitting light, said waveguide comprising:
a transparent substrate;
a first end for receiving light;
a second end for emitting light from one or more output apertures; and
a light scattering portion with an index of refraction substantially different from the transparent substrate, which scatters or reflects light received at the first end so as to emit light from the output apertures.

2. A scale model structure as in claim 1, the light fixture further comprising an opaque outer layer covering the exterior of the waveguide, excluding the first end and the output apertures.

3. A scale model structure as in claim 1, wherein each second end has two or more output apertures emitting approximately equal amounts of light.

4. A scale model structure as in claim 3, wherein each second end has substantially orthogonal output apertures.

5. A scale model structure as in claim 1, wherein the transparent substrate is a plastic; and the light scattering portion comprises an air gap in the transparent substrate.

6. A scale model structure as in claim 1, wherein the opaque outer layer comprises paint.

7. A scale model structure as in claim 1, further comprising a light emitting diode for inputting light to the first end of the waveguide.

8. A scale model structure as in claim 7, wherein the light emitting diode can emit multiple colors.

9. A model train comprising:
at least one light fixture, said light fixture comprising
a waveguide for transmitting light, said waveguide comprising:
a transparent substrate;
a first end for receiving light;
a second end for emitting light from one or more output apertures; and
a light scattering portion with an index of refraction substantially different from the transparent substrate, which scatters or reflects light received at the first end so as to emit light from the output apertures.

10. A model train as in claim 9, the light fixture further comprising an opaque outer layer covering the exterior of the waveguide, excluding the first end and the output apertures.

11. A model train as in claim 9, wherein each second end has two or more output apertures emitting approximately equal amounts of light.

12. A model train as in claim 11, wherein each second end has substantially orthogonal output apertures

13. A model train as in claim 9, wherein the transparent substrate is a plastic; and the light scattering portion comprises an air gap in the transparent substrate.

14. A model train as in claim 9, wherein the opaque outer layer comprises paint.

15. A model train as in claim 9, wherein the opaque outer layer comprises plastic.

16. A model train as in claim 9, further comprising a light emitting diode for inputting light to the first end of the waveguide.

17. A model train as in claim 16, wherein the light emitting diode can emit multiple colors.

18. A light fixture for a scale model structure comprising:
a waveguide for transmitting light comprising:
a transparent substrate;
a first end for receiving light;
a second end for emitting light from one or more output apertures; and
a light scattering portion with an index of refraction substantially different from the transparent substrate, which scatters or reflects light received at the first end so as to emit light from the output apertures.

19. A light fixture as in claim 18, further comprising an opaque outer layer covering the exterior of the waveguide, excluding the first end and the output apertures.

20. A light fixture as in claim 18, wherein the second end has two or more output apertures emitting approximately equal amounts of light.

21. A light fixture as in claim 20, wherein the second end has substantially orthogonal output apertures

22. A light fixture as in claim 18, wherein the transparent substrate is a plastic; and the light scattering portion comprises an air gap in the transparent substrate.

23. A light fixture as in claim 18, wherein the opaque outer layer comprises paint.

24. A light fixture as in claim 18, wherein the opaque outer layer comprises plastic.

25. A light fixture as in claim 18, wherein the waveguide and outer layer are constructed to pass through the exterior of a model train structure; and the marker light at the second end of the waveguide is shaped to resemble a marker light fixture of a prototype train.
